(19) United States
(12) Patent Application Publication
(10) Pub. No.: US 2022/0049539 A1
(43) Pub. Date: Feb. 17, 2022

(54) ANTI-THEFT GATE SYSTEM

(71) Applicant: DOUGLAS EDWARD SMITH, MOUNTAIN VIEW, CA (US)

(72) Inventor: DOUGLAS EDWARD SMITH, MOUNTAIN VIEW, CA (US)

(21) Appl. No.: 17/353,804

(22) Filed: Jun. 21, 2021

Related U.S. Application Data
(60) Provisional application No. 63/065,674, filed on Aug. 14, 2020.

(51) Int. Cl. E05G 1/10; E05F 15/635; E05B 73/00; E05G 1/026

(52) U.S. Cl. CPC E05G 1/10; E05G 1/026; E05B 73/0017; E05F 15/635

(57) ABSTRACT

An anti-theft security system for business entryways that is a housing assembly with at least one sidewall. An entrance in the sidewall is located opposite an exit so a person can move straight through with the sidewall including at least one transparent portion. A sensor assembly on the housing assembly is designed to detect electronic tags on products. Separate entrance and exit retractable doors are opened or closed independently or simultaneously in response to the sensor assembly. At least one control unit and at least one electronic motor assembly is electrically or wirelessly coupled to the sensor. The electronic motor is also coupled to the entrance and exit retractable doors, the doors slidably movable along a track assembly disposed internally, externally, or within the sidewall to open or close the doors. At least one alarm is electrically coupled to the sensor assembly. A control switch controls which doors are closed when a sensor detects a tag and a release actuator may open doors manually.

### CLAIM OF PRIORITY

This application claims priority to and the benefit of U.S. Provisional application Ser. No. 63/065,674, filed on Aug. 14, 2020, with the same title, which is incorporated herein by reference in its entirety.

### FIELD OF THE INVENTION

The inventive concept relates generally to an anti-theft gate.

### BACKGROUND

Currently, there are a number of solutions for shoplift prevention. One of these solutions attempts to use a security guard, but this solution fails to meet the needs of the market because security guards can be expensive. Another solution attempts to utilize security cameras, but this solution is similarly unable to meet the needs of the market because the thief may be gone by the time someone gets to the door. Still another solution seeks to utilize metal detectors, but this solution also fails to meet market needs because metal detectors may not sense items being taken. Therefore, there currently exists a need in the market for an apparatus that prevents shoplifters from exiting with stolen goods.

### SUMMARY OF THE INVENTION

The inventive concept is an anti-theft security system for securing the entryway of a business that has a housing assembly with a closed base portion, a closed top portion, and at least one sidewall assembly. The sidewall assembly has an open entrance portion disposed opposite an open exit portion. The entrance and exit portions are designed to allow a person to walk through the housing assembly substantially unimpeded. At least one transparent portion is a part of the at least one sidewall assembly. At least one sensor assembly is designed to detect at least one active electronic tag assembly disposed on or within at least one product or packaging. An entrance retractable door assembly and an exit retractable door assembly is designed to independently or simultaneously be in an open or closed state. At least one control unit assembly and at least one electronic motor assembly is electrically coupled to the at least one sensor assembly, the at least one electronic motor assembly coupled to the entrance and exit retractable door assemblies, the retractable door assemblies slidably movable along a track assembly disposed internal to, external to, or within the sidewall assembly, the at least one electronic motor assembly designed to open and close at least one retractable door assembly. At least one alarm assembly is electrically coupled to the at least one sensor assembly. A control switch assembly is designed to control whether one or both retractable door assemblies close when the sensor assembly detects at least one tag assembly, thereby giving the option to contain the person or only to prevent the person from leaving. At least one door release activator assembly is designed to be activated manually or automatically to allow the retractable door assemblies to be opened.

In one embodiment of the anti-theft security system for securing the entryway of a business, the alarm assembly is both a light signal and a sound signal.

It would be advantageous to have an anti-theft security system for securing the entryway of a business that is tamper-proof. Still further, it would be advantageous to have an anti-theft security system for securing the entryway of a business that is lockable.

The anti-theft security system for securing the entryway of a business advantageously fills the aforementioned deficiencies by providing an anti-theft gate, which provides a way to prevent thieves from leaving a store with merchandise.

The anti-theft security system for securing the entryway of a business fulfills the need for retail theft prevention.

Among other things, it is an advantage of the anti-theft security system for securing the entryway of a business to provide an anti-theft gate that does not suffer from problems or deficiencies associated with prior solutions. Anti-theft gates that are available today only sound or flash alarms when the detect an item being stolen but do nothing to stop the shoplifter, as in our inventive concept.

It is still further an advantage of the anti-theft security system for securing the entryway of a business to be universal.

Still further, the anti-theft security system for securing the entryway of a business has a control panel.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete and will fully convey the full scope of the inventive concept to those skilled in the art.

### BRIEF DESCRIPTION OF THE DRAWINGS

FIG. 1 illustrates a front view of an anti-theft security system for securing the entryway of a retail business.

FIG. 2 illustrates a back or rear view of the anti-theft security system for securing the entryway of a business.

FIG. 3 illustrates a right side view of the anti-theft security system for securing the entryway of a business.

FIG. 4 illustrates a left side view of the anti-theft security system for securing the entryway of a business.

FIG. 5 illustrates top view of the anti-theft security system for securing the entryway of a business.

FIG. 6 illustrates a bottom view of the anti-theft security system for securing the entryway of a business.

FIG. 7 illustrates a perspective view of the anti-theft security system for securing the entryway of a business.

FIG. 8 illustrates a sensor assembly integrated into the anti-theft security system for securing the entryway of a retail business.

FIG. 9 illustrates multiple housing assemblies and gates.

FIG. 10 illustrates a front view of a control panel.

FIG. 11A-11B illustrate flowcharts of a method of using the anti-theft security system for securing the entryway of a business or secure area.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

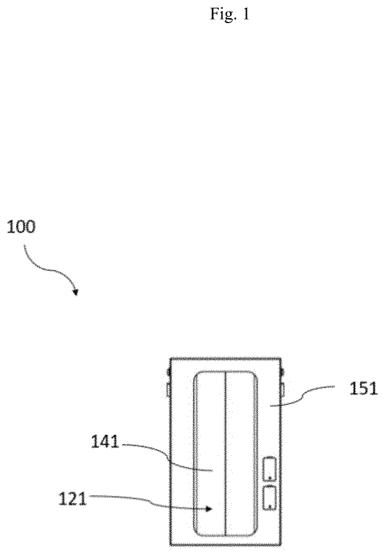

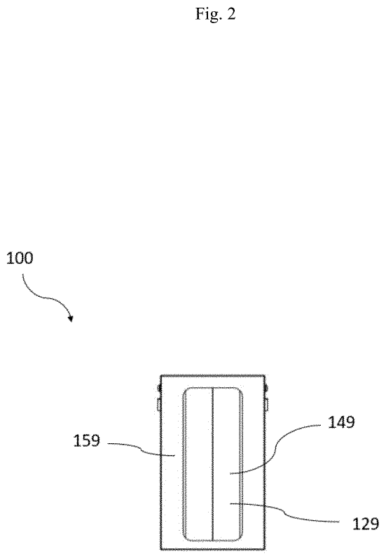

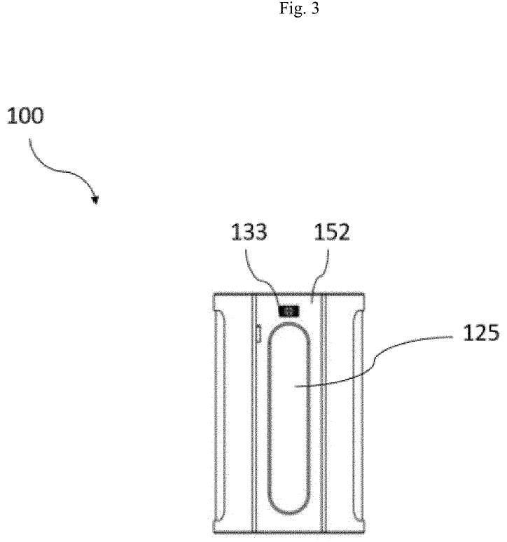

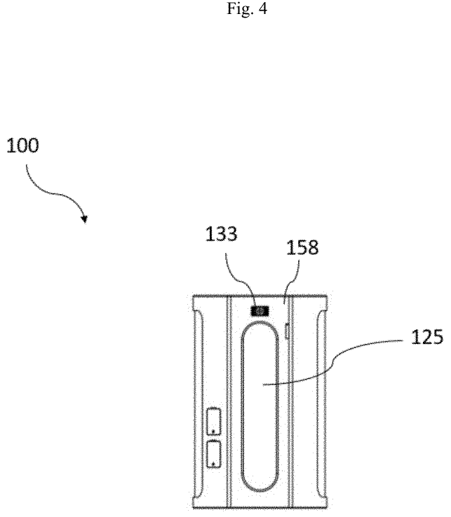

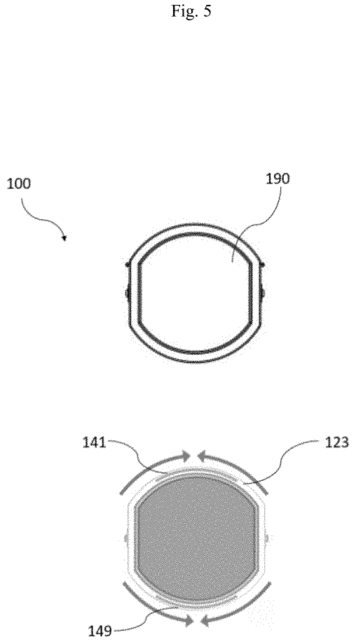

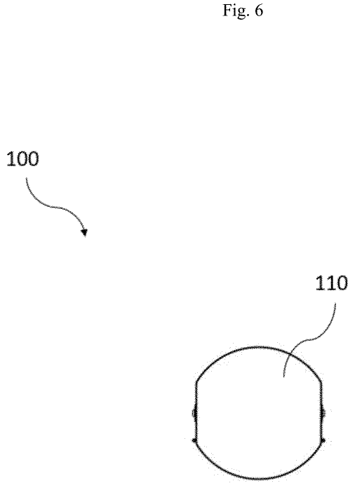

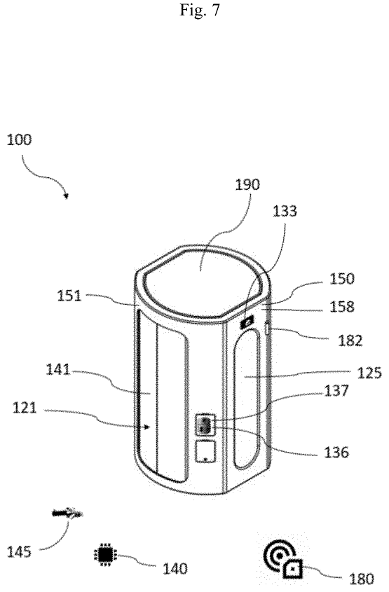

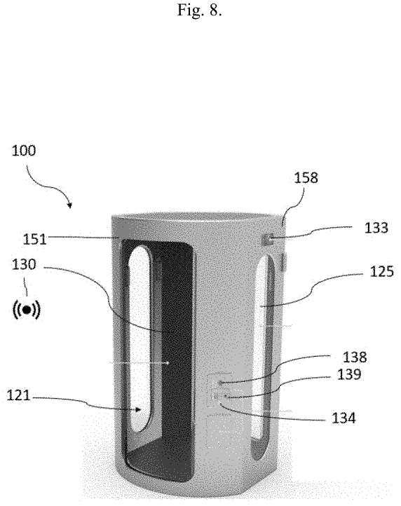

Referring to the Figures, FIGS. 1-8 illustrate the inventive concept is an anti-theft security system 10 for securing the entryway of primarily a retail business, but not necessarily limited to such an application, which has a housing assembly 100 with a closed base portion 110, a closed top portion 190, and at least one sidewall assembly 150. In the example embodiment, the housing assembly 100 is substantially cylindrical with the closed base portion 110, the closed top portion 190, and the sidewall assembly 150 having two oppositely facing flat portions 152, 158 of a width less than the diameter of the housing assembly 100 and designed to abut at least one second housing assembly 900. The sidewall assembly 150 has an open entrance portion 121 disposed opposite an open exit portion 129. The entrance and exit portions 121, 129 are designed to allow a person to walk through the housing assembly 100 substantially unimpeded. At least one transparent portion 125 is a part of the at least one sidewall assembly 150. In the example embodiment, the at least one transparent portion 125 is disposed on each of the two oppositely facing flat portions 152, 158. At least one sensor assembly 130 is designed to detect at least one active electronic tag assembly 180 disposed on or within at least one product or packaging.

In this example embodiment, an entrance retractable door assembly 141 and an exit retractable door assembly 149 is designed to independently or simultaneously be in an open or closed state to affect movement through the housing assembly. In the example embodiment, the retractable door assemblies 141, 149 are substantially bilaterally divided. At least one control unit assembly 140 and at least one electronic motor assembly 145 is electrically or wirelessly (such as RF or Bluetooth™ technology) coupled to the at least one sensor assembly 130, the at least one electronic motor assembly 145 coupled to the entrance and exit retractable door assemblies 141, 149, the retractable door assemblies 141, 149 slidably movable along a track assembly 123 disposed internal to, external to, or within the sidewall assembly 150, the at least one electronic motor assembly 145 designed to open and close at least one retractable door assembly 141, 149.

At least one alarm assembly 133 is electrically coupled to the at least one sensor assembly 130. A control switch assembly 136 is designed to control whether one or both retractable door assemblies 141, 149 are close when the sensor assembly 130 detects at least one tag assembly 180, thereby giving the option to contain the person or only to prevent the person from leaving. At least one door release activator assembly 137 is designed to be activated manually or automatically to allow the retractable door assemblies 141, 149 to be opened.

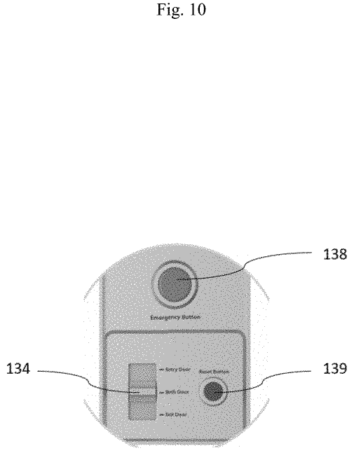

FIGS. 1-8 illustrate that in the example embodiment, the retractable door assemblies 141, 149 are slidably movable along a track assembly 123 disposed substantially within the sidewall assembly 150, an open front portion of the sidewall assembly 151 further defining the open entrance portion of the housing assembly 121 and an open back portion of the sidewall assembly 159 further defining the open exit portion of the housing assembly 129, the at least one electronic motor assembly 145 designed to open and close at least one or more of the entrance retractable door assembly 141 and the exit retractable door assembly 149. In the example embodiment, the at least one door release activator assembly 137 is designed to be activated manually or automatically to allow the retractable door assemblies 141, 149 to be opened, further including, with reference to FIG. 10, an emergency button 138, a reset button 139, and a setting member 134 to open one or more of the back and front retractable door assemblies 141, 149.

FIGS. 1-8 further illustrate that in one embodiment of the anti-theft security system for securing the entryway of a business, the alarm assembly 133 includes at least one of a light signal and a sound signal.

FIGS. 1-8 further illustrate that the anti-theft security system for securing the entryway of a business may have the detected tag assemblies 180 include one or more from a group of: passive RFID tags, active RFID tags, electromagnetic systems, acousto-magnetic systems, microwave systems, and source tagging.

FIGS. 1-8 further illustrate that the anti-theft security system for securing the entryway of a business may have the sensor assembly 130 designed to detect RFID tag LC tank circuits having a resonance peak between from 1.75 MHz to 9.5 MHz.

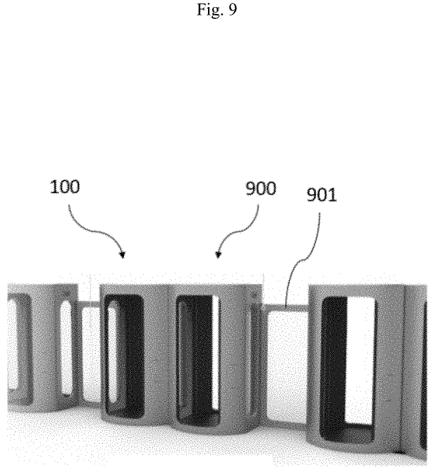

FIGS. 1-8 further illustrate that the anti-theft security system for securing the entryway of a business may have one or more elongate, vertical loop and pin members 182 disposed on an outer portion of the housing assembly 100 designed to couple the housing assembly 100 to, with reference to FIG. 9, one or more of a second housing assembly 900 and a gate member 901.

FIGS. 1-8 further illustrate that the anti-theft security system for securing the entryway of a business may have the at least one door release activator assembly 137 that is designed to be activated manually or automatically to allow the retractable door assemblies 141, 149 to be opened further include an emergency button 138, a reset button 139, and a setting member 134 to open one or more of the exit/back and entrance/front retractable door assemblies 141, 149.

FIGS. 1-8 further illustrate that the anti-theft security system for securing the entryway of a business may have the retractable door assemblies 141, 149 that may be locked in an open or closed state.

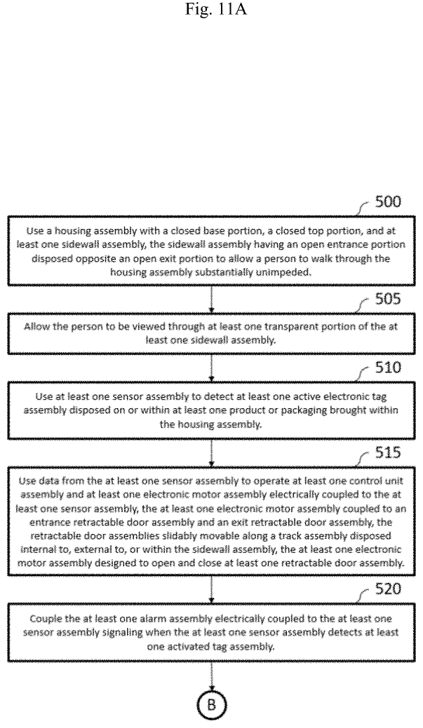

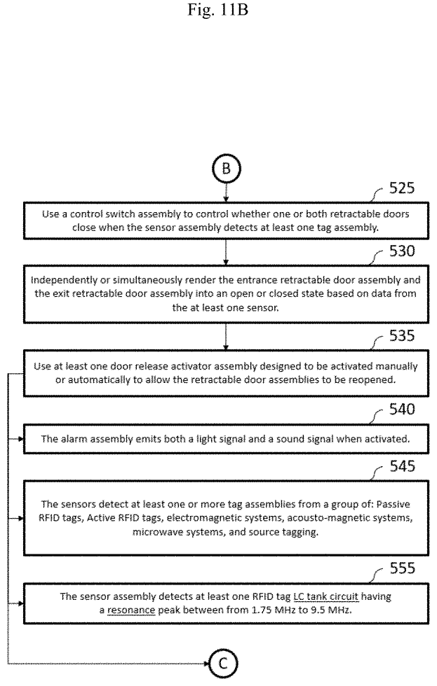

FIGS. 11A-11B are flowcharts that illustrate an example method for using the anti-theft security method for securing the entryway of a business, the method 500 including the step of providing a housing assembly 100 with the closed base portion 110, the closed top portion 190, and at least one sidewall assembly 150, the sidewall assembly 150 having the open entrance portion 121 disposed opposite the open exit portion 129 to allow a person to move or walk through the housing assembly 100 substantially unimpeded. The method further includes step 505, allowing the person to be viewed through at least one transparent portion 125 of the at least one sidewall assembly. The method further includes the step 510, using at least one sensor assembly 130 to detect at least one active electronic tag assembly 180 disposed on or within at least one product or packaging brought within the housing assembly 100.

FIGS. 11A-11B further illustrate that the method includes the step 515, using data from the at least one sensor assembly 130 to operate at least one control unit assembly 140 and at least one electronic motor assembly 145 electrically coupled to the at least one sensor assembly 130, the at least one electronic motor assembly 145 coupled to the entrance retractable door assembly and the exit retractable door assembly, the retractable door assemblies 141, 149 slidably movable along the track assembly 123 disposed internal to, external to, or within the sidewall assembly 150, the at least one electronic motor assembly 145 designed to open and close at least one retractable door assembly. The method further includes step 520, the at least one alarm assembly 133 electrically coupled to the at least one sensor assembly 130 signaling when the at least one sensor assembly 130 detects at least one activated tag assembly 180. The method further includes step 525, using the control switch assembly 136 to control whether one or both retractable doors 141, 149 close when the sensor assembly 130 detects at least one tag assembly 180. The method further includes step 530, independently or simultaneously rendering the entrance retractable door assembly 141 and the exit retractable door assembly 149 into an open or closed state based on data from the at least one sensor assembly 130. The method further includes step 535, using the at least one door release activator assembly 137 designed to be activated manually or automatically to allow the retractable door assemblies 141, 149 to be reopened.

FIGS. 11A-11B further illustrate that the anti-theft security method for securing the entryway of a business may includes step 540, the alarm assembly 133 emitting both the light signal and the sound signal when activated.

FIGS. 11A-11B further illustrate that the anti-theft security method for securing the entryway of a business may include step 545, the sensors detecting at least one or more tag assemblies 180 from the group of: passive RFID tags, active RFID tags, electromagnetic systems, acousto-magnetic systems, microwave systems, and source tagging.

FIGS. 11A-11B further illustrate that the anti-theft security method for securing the entryway of a business may include step 550, the sensor assembly 130 detecting at least one RFID tag LC tank circuit having the resonance peak between from 1.75 MHz to 9.5 MHz.

FIGS. 11A-11B further illustrate that the anti-theft security method for securing the entryway of a business may include step 555, using one or more elongate, vertical loop and pin members 182 disposed on the outer portion of the housing assembly 100 to couple the housing assembly 100 to at least one or more of the second housing assembly 900 and the gate member 901.

The anti-theft security method for securing the entryway of a business may include step 560, activating the at least one door release activator assembly 137 to open retractable doors 141, 149 via one or more of the emergency button 138 and the reset button 139, the reset button 139 further used to open one or more of the back retractable door assembly 149 and the front retractable door assembly 141.

The anti-theft security method for securing the entryway of a business may include step 565, having the retractable door assemblies 141, 149 selectively locked and lockable into an open or closed state.

A sensor and tag assembly as illustrated by the inventive concept may include o-frequencydentification (RFID). RFID uses electromagnetic fields to automatically identify and track tags attached to objects. An RED tag consists of a tiny radio transponder, a radio receiver and transmitter. When triggered by an electromagnetic interrogation pulse from a nearby RFID reader device, the tag transmits digital data, usually an identifying inventory number, back to the reader. This number can be used to detect goods. There are two RFID types. Passive tags are powered by energy from the RFID reader's interrogating radio waves. Active tags are powered by a battery and thus can be read at a greater range from the RFID reader up to hundreds of meters. Either may be used. Unlike a barcode, the tag does not need to be within the line of sight of the reader, so it may be embedded in the tracked object. RFID is one method of automatic identification and data capture (AIDC). RFID tags are used in many industries. ISO/IEC 20248 specifies a digital signature data structure for RFID and barcodes providing data, source and read method authenticity. This work is done within ISO/IEC JTC 1/SC 31 Automatic identification and data capture techniques. Tags can help prevent theft by customers and employees.

Embodiments disclosed herein may include electromagnetic systems. These tags are made of a strip of amorphous metal (metglass), which has a low magnetic saturation value. Except for permanent tags, this strip is also lined with a strip of ferromagnetic material with a moderate coercive field (magnetic “hardness”). Detection is achieved by sensing harmonics and sum or difference signals generated by the non-linear magnetic response of the material under a mixture of low-frequency (in the 10 Hz to 1000 Hz range) magnetic fields. When the ferromagnetic material is magnetized, it biases the amorphous metal strip into saturation, where it no longer produces harmonics. Deactivation of these tags is therefore done with magnetization. Activation requires demagnetization. The EM systems are suitable for libraries to protect books and media. In the retail segment, unlike AM and RF, EM can protect small or round items and products with foil packaging or metal objects, like cosmetics, baby milk cans, medicines, DIY tools, homeware, and the like. EM systems can also detect objects placed in foil bags or in metal briefcases. A further application is the Intellectual property (IP) protection against theft: Security paper with embedded microwires, which is used to detect confidential documents if they are removed from a building. The inventive concept is useful for such IP protection.

Embodiments disclosed herein may include Acousto-magnetic systems. These are similar to magnetic tags in that they are made of two strips: a strip of magnetostrictive, ferromagnetic amorphous metal , and a strip of a magnetically semi-hard metallic strip, which is used as a biasing magnet (to increase signal strength) and to allow deactivation. These strips are not bound together but are free to oscillate mechanically. Amorphous metals are used in such systems due to their good magnetoelastic coupling, which implies that they can efficiently convert magnetic energy into mechanical vibrations. The detectors for such tags emit periodic tonal bursts at about 58 kHz, the same as the resonance frequency of the amorphous strips. This causes the strip to vibrate longitudinally by magnetostriction, and it continues to oscillate after the burst is over. The vibration causes a change in magnetization in the amorphous strip, which induces an AC voltage in the receiver antenna, If this signal meets the required parameters (correct frequency, repetition, etc.), the alarm is activated. When the semi-hard magnet is magnetized, the tag is activated. The magnetized strip makes the amorphous strip respond much more strongly to the detectors because the DC magnetic field given off by the strip offsets the magnetic anisotropy within the amorphous metal. The tag can also be deactivated by demagnetizing the strip, making the response small enough so that it will not be detected by the detectors. AM tags are three-dimensional plastic tags, much thicker than electromagnetic strips and are thus seldom used for books.

Embodiments disclosed herein may include Radio frequency (RFID) systems with the further detail provided. These tags are essentially an LC tank circuit (L for inductor, C for capacitator) that has a resonance peak anywhere from 1.75 MHz to 9.5 MHz. The standard frequency for retail use is 8.2 MHz, but the inventive concept may also use other frequencies. Sensing is achieved by sweeping around the resonant frequency and detecting the dip. Deactivation for 8.2 MHz label tags is typically achieved using a deactivation pad. In the absence of such a device, labels can be rendered inactive by punching a hole, or by covering the circuit with a metallic label, a “detuner”. The deactivation pad functions by partially destroying the capacitor. The deactivator causes a micro short circuit in the label. This is done by submitting the tag to a strong electromagnetic field at the resonant frequency, which induces voltages exceeding the capacitor's breakdown voltage.

In terms of deactivation, Radio Frequency is the most efficient of the 3 technologies (RF, EM, AM—there are no microwave labels) given that the reliable “remote” deactivation distance can be up to 30 cm (11.8 in). It also benefits the user in terms of running costs, since the RF de-activator only activates to send a pulse when a circuit is present. Both EM and AM deactivation units may be on all the time and consume considerably more electricity. The reliability of “remote” deactivation (i.e. non-contact or non-proximity deactivation) capability makes for a fast and efficient throughput at the checkout. Efficiency is an important factor when choosing an overall EAS solution given that time lost attempting to deactivate labels can be an important drag of cashier productivity as well as customer satisfaction if unwanted alarms are caused by tags that have not been effectively deactivated at the point of sale. Deactivation of RF labels is also dependent on the size of the label and the power of the deactivation pad. It is common to find RF deactivation built into barcode flat and vertical scanners at the POS in food retail especially in Europe and Asia where RF EAS technology has been the standard for nearly a decade. In apparel retail deactivation usually takes the form of flat pads of approx. 30×30 cm.

Embodiments disclosed herein may include Microwave systems. These permanent tags are made of a non-linear element (a diode) coupled to one micro ave and one electrostatic antenna. At the exit, one antenna emits a low-frequency (about 100 kHz) field, and another one emits a microwave field. The tag acts as a mixer re-emitting a combination of signals from both fields. This modulated signal triggers the alarm. These tags are permanent and somewhat costly. They are mostly used in clothing stores and have practically been withdrawn from use. The inventive concept, however, may still detect them in some embodiments.

Embodiments disclosed herein may include Source tagging. Source tagging is the application of EAS security tags at the source, the supplier or manufacturer, instead of at the retail side of the chain. For the retailer, source tagging eliminates the labor expense needed to apply the EAS tags themselves, and reduces the time between receipt of merchandise and when the merchandise is ready for sale. For the supplier, the main benefit is the preservation of the retail packaging aesthetics by easing the application of security tags within product packaging. Source tagging allows the EAS tags to be concealed and more difficult to remove. The high-speed application of EAS labels, suited for commercial packaging processes, was perfected via modifications to standard pressure-sensitive label applicators and was developed and introduced by Craig Patterson, initially for Hewlett Packard print cartridges. Today, consumer goods are source tagged at high speeds with the EAS label incorporated into the packaging or the product itself. The most common source tags are AM strips and 8.2 MHz radio frequency labels. Most manufacturers use both when source tagging in the USA. in Europe there is little demand for AM tagging given that the Food and Department Store environments are dominated by RF technology.

The following patents are incorporated by reference in their entireties: U.S. Pat. Nos. 6,304,181, 7,782,207, and 10,438,479.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. An anti-theft security system for securing an entryway of a secure area comprising:
a housing assembly with a closed base portion, a closed top portion, and at least one sidewall assembly, the at least one sidewall assembly having an open entrance portion disposed opposite an open exit portion, the entrance and exit portions adapted to allow a person to move through the housing assembly substantially unimpeded;
at least one transparent portion of the at least one sidewall assembly;
at least one sensor assembly located within the housing assembly and adapted to detect at least one electronic tag assembly disposed on or within at least one product or packaging;
an entrance retractable door assembly and an exit retractable door assembly supported by the housing and adapted to independently or simultaneously be in an open or closed state to affect movement through the housing assembly;
at least one control unit assembly and at least one electronic motor assembly electrically or wirelessly coupled to the at least one sensor assembly, the at least one electronic motor assembly coupled to the entrance and exit retractable door assemblies, wherein the retractable door assemblies are slidably movable along a track assembly disposed internal to, external to, or within the sidewall assembly, the at least one electronic motor assembly adapted to open and close at least one of the entrance or exit retractable door assemblies;
a control switch assembly adapted to control whether one or both retractable doors close when the sensor assembly detects the at least one tag assembly; and
at least one door release activator assembly adapted to be activated manually or automatically to allow the retractable door assemblies to be opened.

2. The anti-theft security system of claim 1 further comprising at least one alarm assembly electrically coupled to the at least one sensor assembly, wherein the alarm assembly includes at least one of a light signal and a sound signal.

3. The anti-theft security system of claim 1 wherein the detected tag assembly is selected from the group consisting of passive RFID tags, active RFID tags, electromagnetic systems, acousto-magnetic systems, microwave systems, and source tagging.

4. The anti-theft security system of claim 1 wherein the sensor assembly is adapted to detect RFID tag LC tank circuits having a resonance peak between from 1.75 MHz to 9.5 MHz.

5. The anti-theft security system of claim 1 wherein one or more elongate, vertical loop and pin members disposed on an outer portion of the housing assembly are adapted to couple the housing assembly to one or more of a second housing assembly and a gate member.

6. The anti-theft security system of claim 1 wherein the at least one of the entrance or exit door release activator assemblies further includes at least one of an emergency button, a reset button, and a setting member to open one or more of the back and front retractable door assembly.

7. The anti-theft security system of claim 1 wherein the retractable door assemblies may be locked in an open or closed state.

8. An anti-theft security system for securing the entryway of a retail business comprising:
a substantially cylindrical housing assembly with a closed base portion, a closed top portion, and a sidewall assembly having two oppositely facing flat portions of a width less than the diameter of the cylindrical housing assembly and adapted to abut at least one second housing assembly, the sidewall assembly having an open entrance portion disposed opposite an open exit portion, the entrance and exit portions adapted to allow a person to move through the housing assembly substantially unimpeded;
at least one transparent portion of the at least one sidewall assembly disposed on each of the two oppositely facing flat portions;
at least one interior sensor assembly disposed on the housing and adapted to detect at least one electronic tag assembly disposed on or within at least one product or packaging;
a bilaterally divided entrance retractable door assembly and a bilaterally divided exit retractable door assembly adapted to independently or simultaneously be in an open or closed state along correspondingly vertical bilateral divisions;
at least one control unit assembly and at least one electronic motor assembly electrically or wirelessly coupled to the at least one sensor assembly, the at least one electronic motor assembly coupled to the entrance and exit retractable door assemblies, wherein the retractable door assemblies are slidably movable along a track assembly disposed substantially within the sidewall assembly, an open front portion of the sidewall assembly further defining the open entrance portion of the housing assembly and an open back portion of the sidewall assembly further defining the open exit portion of the housing assembly, the at least one electronic motor assembly adapted to open and close at least one or more of the entrance retractable door assembly and the exit retractable door assembly;
a control switch assembly adapted to control whether one or both retractable doors close when the sensor assembly detects at least one tag assembly; and
at least one door release activator assembly adapted to be activated manually or automatically to allow the retractable door assemblies to be opened, further including at least one of an emergency button, a reset button, and a setting member to open one or more of the exit and entrance retractable door assemblies.

9. The anti-theft security system of claim 8 further comprising at least one alarm assembly electrically coupled to the at least one sensor assembly, wherein the alarm assembly includes at least one of a light signal and a sound signal.

10. The anti-theft security system of claim 8 wherein the at least one detected tag assembly includes at least one of a passive RFID tags, an active RFID tags, electromagnetic systems, acousto-magnetic systems, microwave systems, and source tagging.

11. The anti-theft security system of claim 8 wherein the sensor assembly is adapted to detect RFID tag LC tank circuits having a resonance peak between from 1.75 MHz to 9.5 MHz.

12. The anti-theft security system of claim 8 wherein one or more elongate, vertical loop and pin members disposed on an outer portion of the housing assembly are adapted to couple the housing assembly to one or more of a second housing assembly and a gate member.

13. The anti-theft security system of claim 8 wherein the retractable door assemblies may be locked in an open or closed state.

14. An anti-theft security method for securing the entryway of a retail business, the method comprising:
providing a housing assembly with a closed base portion, a closed top portion, and at least one sidewall assembly, the sidewall assembly having an open entrance portion disposed opposite an open exit portion, the entrance and exit portions adapted to allow a person to move through the housing assembly substantially unimpeded;
providing at least one transparent portion of the at least one sidewall assembly to allow viewing of the person within the housing assembly; detecting at least one active electronic tag assembly disposed on or within at least one product or packaging brought within the housing assembly via at least one sensor assembly disposed in the housing assembly;
responding to data from the at least one sensor assembly to operate at least one control unit assembly and at least one electronic motor assembly electrically coupled to the at least one sensor assembly, the at least one electronic motor assembly coupled to an entrance retractable door assembly and an exit retractable door assembly, the retractable door assemblies slidably movable along a track assembly disposed internal to, external to, or within the sidewall assembly, the at least one electronic motor assembly adapted to open and close at least one retractable door assembly;
using a control switch assembly to control whether one or both retractable doors close when the sensor assembly detects at least one tag assembly;
independently or simultaneously rendering the entrance retractable door assembly and the exit retractable door assembly into an open or closed state based on data from the at least one sensor; and
using at least one door release activator assembly adapted to be activated manually or automatically to allow the retractable door assemblies to be reopened.

15. The anti-theft security method for securing the entryway of claim 14 further comprising the step of providing at least one alarm assembly electrically coupled to the at least one sensor assembly signaling when the at least one sensor assembly detects at least one activated tag assembly, wherein the alarm assembly emits both a light signal and a sound signal when activated.

16. The anti-theft security method for securing the entryway of claim 14 wherein the at least one sensor assembly detects at least one or more tag assemblies from a group consisting of: passive RFID tags, active RFID tags, electromagnetic systems, acousto-magnetic systems, microwave systems, and source tagging.

17. The anti-theft security method for securing the entryway of claim 14 wherein the at least one sensor assembly detects at least one RFID tag LC tank circuit having a resonance peak between from 1.75 MHz to 9.5 MHz.

18. The anti-theft security method for securing the entryway of claim 14 wherein one or more elongate, vertical loop and pin members disposed on an outer portion of the housing assembly are used to couple the housing assembly to at least one or more of a second housing assembly and a gate member.

19. The anti-theft security method for securing the entryway of claim 14 wherein the at least one door release activator assembly is activated to open doors via one or more of an emergency button and a reset button, the reset button further used to open one or more of the exit retractable door assembly and the entrance retractable door assembly.

20. The anti-theft security method for securing the entryway of claim 14 wherein the retractable door assemblies are selectively locked and lockable into an open or closed state.
